(19) United States
(12) Patent Application Publication
(10) Pub. No.: US 2026/0153599 A1
(43) Pub. Date: Jun. 4, 2026

(54) ELECTROMAGNETIC WAVE TRANSMISSIVE COVER

(71) Applicant: TOYODA GOSEI CO., LTD., Kiyosu-shi (JP)

(72) Inventors: Tomoki KAWASAKI, Kiyosu-shi (JP); Shota YAMAMORI, Kiyosu-shi (JP); Akiko KIMURA, Kiyosu-shi (JP)

(21) Appl. No.: 19/395,341

(22) Filed: Nov. 20, 2025

(30) Foreign Application Priority Data
Nov. 29, 2024 (JP) 2024-208116

(51) Int. Cl. G01S 7/40; G01S 7/02; G01S 13/931; H05B 3/56

(52) U.S. Cl. CPC G01S 7/4047; G01S 7/027; G01S 13/931; H05B 3/56; G01S 2013/93185; G01S 2013/9319; H05B 2203/003; H05B 2203/005; H05B 2214/02

(57) ABSTRACT

Provided is a technology that prevents partial concentration of heat generation in a cover body portion of an electromagnetic wave transmissive cover. A heater wire 50 of an electromagnetic wave transmissive cover 3 is configured such that, in general link portions 51s of connection end portions 51, an interval between each connection end portion 51 present at an endmost position in an arrangement direction and the connection end portion 51 adjacent thereto is greater than an interval between two connection end portions 51 present on a center side in the arrangement direction, or is configured such that, in the general link portions 51s of the connection end portions 51, electric resistances of the connection end portions 51 present at endmost positions on both sides in the arrangement direction are smaller than electric resistances of two connection end portions 51 present on a center side in the arrangement direction.

### TECHNICAL FIELD

The present disclosure relates to an electromagnetic wave transmissive cover provided on the outer side of an electromagnetic wave radar.

### BACKGROUND ART

In recent years, development of driving assistance systems for vehicles has been actively performed, and various types of electromagnetic wave radars used in such driving systems are attached to vehicles.

As types of the electromagnetic wave radars, a millimeter-wave radar, a laser radar, and the like are known. These types of electromagnetic wave radars are used in adaptive cruise control (ACC) for vehicles.

The ACC is technology in which traveling information such as an inter-vehicle distance and a relative velocity between a front vehicle and the own vehicle is measured by a sensor provided on the front side of the vehicle, and a throttle and a brake are controlled on the basis of the traveling information so as to increase or decrease the speed of the own vehicle, thereby controlling the inter-vehicle distance.

In recent years, the ACC has been focused on as one of core technologies of an intelligent transportation system (ITS) for achieving congestion mitigation and decrease in the number of accidents. A millimeter-wave radar which is a type of electromagnetic wave radar transmits a millimeter wave having a frequency of 30 GHz to 300 GHz and a wavelength of 1 to 10 mm, and receives a millimeter wave reflected after hitting objects. From a difference between the transmitted wave and the received wave, the inter-vehicle distance and the relative velocity between the front vehicle and the own vehicle can be calculated.

As another example of electromagnetic wave radars, light detection and ranging (LiDAR) is known. The LiDAR is remote sensing technology using light and is used for driving assistance systems.

In the LiDAR, light having a comparatively short wavelength is emitted to an object using a laser, and the light reflected after hitting the object is detected. Among LiDAR technologies, the one using near infrared light is advantageous in detecting an obstacle at a comparatively short distance.

In the various types of electromagnetic wave radars described above, an emission portion and a detection portion are provided on an outermost side of a vehicle (i.e., a front end side, a lateral end side, a rear end side, or the like of a vehicle). If the emission portion and the detection portion are visually recognized from the outside of the vehicle, the design property of the vehicle is impaired. Therefore, on the outer side of the emission portion and the detection portion, an electromagnetic wave transmissive cover that covers these portions and allows transmission of a target electromagnetic wave therethrough is generally provided. In the specification, an apparatus including an electromagnetic wave transmissive cover and an electromagnetic wave radar is referred to as an electromagnetic wave radar unit, as necessary.

The electromagnetic wave transmissive cover is a part exposed to the outside of a vehicle compartment, among parts of the electromagnetic wave radar unit, and is provided on the outer side of the electromagnetic wave radar, in other words, on the forward side in the electromagnetic wave emission direction of the emission portion with respect to the electromagnetic wave radar. The electromagnetic wave transmissive cover may be considered to be located on an electromagnetic wave path of an electromagnetic wave radar.

Since the electromagnetic wave transmissive cover is a part exposed to the outside of a vehicle compartment, the electromagnetic wave transmissive cover may be frosted in a cold condition or snow may be deposited thereon in a snowy condition. When the electromagnetic wave transmissive cover is covered with frost or snow, the sensing function of the electromagnetic wave radar located on the back side, i.e., the deep side, of the cover, the communication function of a communication unit of the electromagnetic wave radar, and the like may be hindered.

Japanese Laid-Open Patent Publication No. 2023-46849 shows an invention regarding an electromagnetic wave transmissive cover for covering a millimeter-wave radar which is a type of electromagnetic wave radar. The electromagnetic wave transmissive cover shown in Japanese Laid-Open Patent Publication No. 2023-46849 is provided on a path of a millimeter wave transmitted and received by a millimeter-wave radar (sensor 2), and includes a cover body portion (substrate 7, decorative layer 8, transparent layer 9) made of resin, and a heater portion (heater sheet 6) integrated with the cover body portion. In the electromagnetic wave transmissive cover of this type, heater wires 11 and 12 of the heater portion are energized to generate heat, thus melting frost or snow covering the electromagnetic wave transmissive cover. Owing to this, the sensing function, the communication function, and the like of the electromagnetic wave radar may be prevented from being hindered by frost or snow.

### SUMMARY OF INVENTION

### Technical Problem

As described above, providing the heater portion to the electromagnetic wave transmissive cover enables melting of frost or snow covering the electromagnetic wave transmissive cover.

Meanwhile, the conventional electromagnetic wave transmissive cover having the heater portion is likely to have lower durability as compared to an electromagnetic wave transmissive cover having no heater portion.

Specifically, in a conventional electromagnetic wave transmissive cover having such a heater portion, heat generation is likely to concentrate on a part near a connection end of a heater wire in the cover body portion. Then, if the heat generation amount at this part is excessive, use as an electromagnetic wave transmissive cover is hindered.

The present disclosure has been made in view of the above circumstances, and an object of the present disclosure is to provide a technology that prevents partial concentration of heat generation in a cover body portion of an electromagnetic wave transmissive cover.

### Solution to Problem

An electromagnetic wave transmissive cover according to a first aspect of the present disclosure to achieve the above object is an electromagnetic wave transmissive cover provided on an outer side of an electromagnetic wave radar, the electromagnetic wave transmissive cover including: a cover body portion formed in a plate shape and having an electromagnetic wave transmitting property, the cover body portion being made of a resin material; and a heater portion including two heater wires and provided integrally with the cover body portion. Each of the heater wires includes connection end portions which are both ends, and a general heater portion which is a remaining part and links the two connection end portions. The connection end portions are arranged side by side in a connection region which is an end portion of the electromagnetic wave transmissive cover and extends outward. Each of the connection end portions includes a general link portion contiguous to the general heater portion, and a crossing extending portion contiguous to the general link portion and extending in a direction crossing the general link portion. In the general link portions, among the four connection end portions of the two heater wires, an interval between each connection end portion present at an endmost position in an arrangement direction and the connection end portion adjacent thereto is greater than an interval between the two connection end portions present on a center side in the arrangement direction.

An electromagnetic wave transmissive cover according to a second aspect of the present disclosure to achieve the above object is an electromagnetic wave transmissive cover provided on an outer side of an electromagnetic wave radar, the electromagnetic wave transmissive cover including: a cover body portion formed in a plate shape and having an electromagnetic wave transmitting property, the cover body portion being made of a resin material; and a heater portion including two heater wires and provided integrally with the cover body portion. Each of the heater wires includes connection end portions which are both ends, and a general heater portion which is a remaining part and links the two connection end portions. The connection end portions are arranged side by side in a connection region which is an end portion of the electromagnetic wave transmissive cover and extends outward. Each of the connection end portions includes a general link portion contiguous to the general heater portion, and a crossing extending portion contiguous to the general link portion and extending in a direction crossing the general link portion. In the general link portions, among the four connection end portions of the two heater wires, electric resistances of the connection end portions present at endmost positions on both sides in an arrangement direction are smaller than electric resistances of the two connection end portions present on a center side in the arrangement direction.

The technology of the present disclosure prevents partial concentration of heat generation in a cover body portion of an electromagnetic wave transmissive cover.

### BRIEF DESCRIPTION OF DRAWINGS

FIG. 1 schematically illustrates an electromagnetic wave radar unit of embodiment 1 including an electromagnetic wave transmissive cover of embodiment 1 as seen from an outer side;

FIG. 2 schematically illustrates the positional relationship between a cover body portion and a heater portion in the electromagnetic wave transmissive cover of embodiment 1;

FIG. 3 schematically illustrates a state in which the electromagnetic wave transmissive cover of embodiment 1 is cut in a thickness direction;

FIG. 4 schematically illustrates a connection region and connection end portions in the electromagnetic wave transmissive cover of embodiment 1;

FIG. 5 schematically illustrates the positional relationship between a cover body portion and a heater portion in an electromagnetic wave transmissive cover of a comparative example;

FIG. 6 schematically illustrates a state in which the electromagnetic wave transmissive cover of the comparative example is cut in a thickness direction; and

FIG. 7 schematically illustrates a connection region and connection end portions in the electromagnetic wave transmissive cover of the comparative example.

### DESCRIPTION OF EMBODIMENTS

The inventor of the present disclosure has conducted thorough studies in order to prevent partial concentration of heat generation in the electromagnetic wave transmissive cover. The inventor has focused on a fact that partial concentration of heat generation in the electromagnetic wave transmissive cover is likely to occur in a connection region of the electromagnetic wave transmissive cover.

The connection region of the electromagnetic wave transmissive cover is an end portion of the electromagnetic wave transmissive cover and is a part extending outward of the electromagnetic wave transmissive cover.

In the connection region of the electromagnetic wave transmissive cover, connection end portions which are both ends of each heater wire are arranged side by side. The inventor has inferred that partial concentration of heat generation in the electromagnetic wave transmissive cover is due to the connection end portions of the heater wires.

Each heater wire has two connection end portions which are both end portions, and a general heater portion linking the two connection end portions. The general heater portion is, of the heater wire, a part having a heating function. The connection end portions are, of the heater wire, parts electrically connected to another element device such as a power supply or a control device.

The general heater portions of the heater wires are located in a heating region which is a target to be heated by the heater portion, of the electromagnetic wave transmissive cover. The connection end portions of the heater wires are located in the connection region of the electromagnetic wave transmissive cover.

The heating region is a main region of the electromagnetic wave transmissive cover. Of the heater wire, the general heater portion located in the heating region is a part that generates heat by being supplied with power and thus has a function of heating the heating region. In order to uniformly heat the entirety of the heating region, generally, the general heater portion is folded at substantially equal intervals and arranged substantially uniformly over the entirety of the heating region.

The connection region is a sub region of the electromagnetic wave transmissive cover. Of the heater wire, the connection end portions located in the connection region are connected to the element device and thus have a function of electrically connecting the element device and the heater portion via a wire. The connection region is located at an end portion of the electromagnetic wave transmissive cover and extends outward of the electromagnetic wave transmissive cover. The connection end portions of the heater wires are gathered in the connection region and arranged side by side in the connection region.

In order to make the electromagnetic wave transmissive cover compact, the connection region of the electromagnetic wave transmissive cover generally has a narrow width as compared to the heating region. Therefore, in the connection region, the connection end portions are located close to each other. If the number of heater wires is large, the number of connection end portions located in the connection region also increases, and the connection end portions adjacent to each other in the connection region come closer to each other.

The inventor has come up with such a thought that, in a case where the electromagnetic wave transmissive cover has two or more heater wires, the adjacent connection end portions are excessively close to each other, so that the temperatures of the connection end portions of the heater wires excessively increase and thus the aforementioned partial concentration of heat generation occurs.

On the basis of the above thought, the inventor has aimed at preventing excessive temperature increase in the heater wires at the connection end portions.

In the electromagnetic wave transmissive cover according to the first aspect of the present disclosure, adjacent connection end portions are arranged at appropriate intervals, thereby preventing excessive temperature increase in the heater wires at the connection end portions.

In general, the connection end portions of the heater portion in the electromagnetic wave transmissive cover extend toward the inner side relative to the electromagnetic wave transmissive cover. This is because the element device connected to the connection end portions is generally located on the inner side relative to the electromagnetic wave transmissive cover, in other words, on the back side in the emission direction of an electromagnetic wave emission device included in an electromagnetic wave radar.

Specifically, a general link portion which is a part on the general heater portion side, of the connection end portion, extends contiguously to the general heater portion. Then, a crossing extending portion which is a remaining part of the connection end portion is contiguous to the general link portion and extends in a direction crossing the general link portion. Therefore, the connection end portion can be considered to have a bent shape. The crossing extending portion is, of the connection end portion, a part that is actually connected to the element device such as a power supply.

The inventor of the present disclosure has focused on, in the connection end portion having a bent shape, particularly, a general link portion P1, a crossing extending portion P3, and a boundary part (bending start portion) P2 of the crossing extending portion with the general link portion P1, and has measured temperatures of these portions. The positions of the above P1 to P3 correspond to the positions of portions shown in FIG. 6.

As a result, the inventor has found that the temperatures of the above portions satisfy P1>P2>P3 and concentration of heat generation is particularly great in the general link portion. On the basis of this, the inventor has revised the configuration of the connection end portion in the general link portion, thus aiming at preventing partial concentration of heat generation in the electromagnetic wave transmissive cover.

In the electromagnetic wave transmissive cover according to the first aspect, in the general link portions, the adjacent connection end portions are arranged at appropriate intervals. Specifically, in the general link portions, among the four connection end portions of the two heater wires, the interval between each connection end portion present at the endmost position in the arrangement direction and the connection end portion adjacent thereto is set to be greater than the interval between the two connection end portions present on the center side in the arrangement direction.

Thus, in the electromagnetic wave transmissive cover according to the first aspect, excessive temperature increase in the heater wires at the connection end portions is prevented. As described also in the section of embodiments later, in actuality, the electromagnetic wave transmissive cover has successfully prevented partial concentration of heat generation in the electromagnetic wave transmissive cover.

In the electromagnetic wave transmissive cover according to the second aspect of the present disclosure, in the general link portions, the electric resistances of some of the plurality of connection end portions are set to be smaller than the electric resistances of others, whereby excessive temperature increase in the heater wires at the connection end portions is prevented.

Specifically, in the electromagnetic wave transmissive cover according to the second aspect, in the general link portions, among the four connection end portions of the two heater wires, the electric resistances of the connection end portions present at the endmost positions on both sides in the arrangement direction are set to be smaller than the electric resistances of the two connection end portions present on the center side in the arrangement direction.

Thus, also in the electromagnetic wave transmissive cover according to the second aspect, excessive temperature increase in the heater wires at the connection end portions is prevented.

Hereinafter, the electromagnetic wave transmissive cover according to the present disclosure will be described for each component thereof.

Unless otherwise specified, a numerical range “x to y” described in the specification includes a lower limit x and an upper limit y. Such an upper limit value and a lower limit value, and values described in embodiments, may be arbitrarily combined to form a numerical range. Further, any values selected from such a numerical range may be used as an upper limit value and a lower limit value.

As used herein, an electromagnetic wave radar unit according to the first aspect refers to a unit including an electromagnetic wave radar and the electromagnetic wave transmissive cover according to the first aspect of the present disclosure. In addition, an electromagnetic wave radar unit according to the second aspect refers to a unit including an electromagnetic wave radar and the electromagnetic wave transmissive cover according to the second aspect of the present disclosure.

As used herein, unless otherwise specified, description of the electromagnetic wave transmissive cover in the electromagnetic wave radar unit according to the first aspect applies also to the electromagnetic wave transmissive cover according to the first aspect, and description of the electromagnetic wave transmissive cover according to the first aspect applies also to the electromagnetic wave transmissive cover in the electromagnetic wave radar unit according to the first aspect. Similarly, description of the electromagnetic wave transmissive cover in the electromagnetic wave radar unit according to the second aspect applies also to the electromagnetic wave transmissive cover according to the second aspect, and description of the electromagnetic wave transmissive cover according to the second aspect applies also to the electromagnetic wave transmissive cover in the electromagnetic wave radar unit according to the second aspect.

As used herein, unless otherwise specified, the wording “electromagnetic wave radar unit” refers to both of the electromagnetic wave radar unit according to the first aspect and the electromagnetic wave radar unit according to the second aspect, and unless otherwise specified, the wording “electromagnetic wave transmissive cover” refers to both of the electromagnetic wave transmissive cover according to the first aspect of the present disclosure and the electromagnetic wave transmissive cover according to the second aspect of the present disclosure.

As the electromagnetic wave radar in the electromagnetic wave radar unit, a millimeter-wave radar, a laser radar, LiDAR, or the like may be preferably selected as described above, but the electromagnetic wave radar is not limited thereto.

The electromagnetic wave transmissive cover according to the present disclosure includes: a cover body portion formed in a plate shape and having an electromagnetic wave transmitting property, the cover body portion being made of a resin material; and a heater portion including two heater wires and provided integrally with the cover body portion.

The electromagnetic wave transmissive cover according to the present disclosure is provided on the outer side of the electromagnetic wave radar, in other words, on the forward side in the emission direction of the electromagnetic wave emission device included in the electromagnetic wave radar. The electromagnetic wave transmissive cover is required to have an electromagnetic wave transmitting property. The heater portion of the electromagnetic wave transmissive cover includes heater wires, and the heater wires are hardly expected to have a high electromagnetic wave transmitting property. Therefore, the cover body portion mainly ensures an electromagnetic wave transmitting property in the electromagnetic wave transmissive cover according to the present disclosure.

The cover body portion is made of a resin material, is formed in a plate shape, and has an electromagnetic wave transmitting property. Of the cover body portion, particularly a region located on the forward side in the emission direction of the electromagnetic wave emission device in the electromagnetic wave radar preferably has a uniform thickness.

As the material of the cover body portion, a resin material is used. Here, the resin material is a material containing resin as a main component, and may contain various kinds of additives. Here, the main component means that the ratio of resin is 90% by mass or more when the ratio of the total resin material is 100% by mass.

As the resin used for the cover body portion, at least one kind is preferably selected from polycarbonate (PC), acrylic resin, polypropylene (PP), acrylonitrile-ethylene-propylene-diene rubber styrene copolymer resin (AES), and the like.

As the resin used for the cover body portion, a resin that is hardly deformed even when the temperature of the heater wire increases is preferably selected. From this point of view, a resin having a glass transition temperature that is high to a certain extent is preferably selected as the resin for the cover body portion.

Specifically, as the resin used for the cover body portion, a resin having a glass transition temperature of 120° C. or more, 115° C. or more, or 110° C. or more is preferably selected. The glass transition temperature of the resin used for the cover body portion particularly has no upper limit, but, for example, a resin having a glass transition temperature of 140° C. or less is preferably used.

The cover body portion may have a single-layer structure or a multilayer structure.

In a case where the cover body portion has a multilayer structure, for example, the cover body portion may be obtained such that a design layer that enables indication of various designs is formed on a substrate layer made of a resin material by means of painting, printing, metal deposition, or the like, or may be obtained by further forming a coat layer on the design layer.

The above substrate in the cover body portion may also have a single-layer structure or a multilayer structure having two or more layers. In a case where the substrate has a multilayer structure, the layers may be made of the same material or may be made of different materials.

The heater portion includes two heater wires and is provided integrally with the cover body portion.

The heater portion includes two heater wires, and as a matter of course, may include three or more heater wires. The heater wires are configured to generate heat by being supplied with power, and the material thereof is not particularly limited. As the material, metal having a high specific resistance, e.g., an alloy (nichrome) containing nickel and chrome, or stainless steel, is preferably used.

A method for forming the heater wires is not particularly limited. For example, the heater wires may be formed by forming the above metal or alloy in a wire shape and integrating the wire-shaped metal or alloy with the cover body portion by means of adhesion, welding, insert molding, or the like. Alternatively, the heater wires may be formed by printing a composite material of a resin and powder of the above metal on the cover body portion.

Each heater wire has two connection end portions which are both end portions thereof, and a part between the two connection end portions. The connection end portions are, of the heater wire, parts arranged side by side in the connection region of the electromagnetic wave transmissive cover. The connection end portions are parts connected to an element device and thus having a function of electrically connecting the element device and the heater portion via a wire, as described above.

Of the heater wire, a part between the two connection end portions, in other words, a part linking the two connection end portions is located in the heating region which is a main region of the electromagnetic wave transmissive cover, and has a function of heating the heating region. This part of the heater wire is referred to as a general heater portion.

Reasonably in terms of function, the connection region of the electromagnetic wave transmissive cover where the connection end portions of the heater wires are located is set to be smaller than the heating region of the electromagnetic wave transmissive cover where the general heater portions of the heater wires are located.

Specifically, where a projected area of the heating region of the electromagnetic wave transmissive cover is defined as 100% by area, a projected area of the connection region of the electromagnetic wave transmissive cover is preferably 20% by area or less, 15% by area or less, or 10% by area or less. Here, the projected area refers to a projected area obtained by projecting each part of the electromagnetic wave transmissive cover in the thickness direction thereof.

The connection region is located at an end portion of the electromagnetic wave transmissive cover and extends outward of the electromagnetic wave transmissive cover. The connection region preferably has a strip shape with a longitudinal direction directed in the extending direction.

The extending direction of the connection region is an outward direction of the electromagnetic wave transmissive cover, and may be set appropriately in accordance with the positional relationship between the electromagnetic wave transmissive cover and the element device. For example, the connection region may extend outward in the radial direction of the electromagnetic wave transmissive cover, or may extend to the back side of the electromagnetic wave transmissive cover.

The general heater portion is arranged substantially uniformly over the entirety of the heating region of the electromagnetic wave transmissive cover, and may be folded a plurality of times in a meandering shape or may be wound in a whorl shape, for example. In any case, the connection end portions of the heater wires are gathered in the connection region, and therefore, of the general heater portions of the heater wires, parts on the connection end portion side are located near the connection region.

The connection end portions of the heater wires are arranged side by side in the connection region. The connection end portions may be arranged in parallel to each other, and some or all of them may not necessarily be arranged in parallel to each other. However, in the general link portions, the connection end portions are preferably arranged in parallel to each other.

As described above, each connection end portion has a bent shape having the general link portion contiguous to the general heater portion, and the crossing extending portion contiguous to the general link portion and extending in a direction crossing the general link portion.

The crossing extending portion may extend straightly, may extend straightly while bending at two or more multiple stages, or may extend in a curved shape.

A crossing angle θ of the crossing extending portion with respect to the general link portion is not particularly limited. However, the smaller the crossing angle θ is, the greater the effect of the electromagnetic wave transmissive cover according to the present disclosure is. From this point of view, the crossing angle θ is preferably in a range of 0°<θ<150°, a range of 0°<θ<120°, or a range of 0°<θ<100°, for example.

The crossing angle θ of the crossing extending portion with respect to the general link portion may be simply a crossing angle between the general link portion and the crossing extending portion, or may be a crossing angle between a tangent to the general link portion and a tangent to the crossing extending portion.

In the electromagnetic wave transmissive cover according to the first aspect of the present disclosure, in the general link portions, among the four connection end portions of the two heater wires, an interval between each connection end portion present at the endmost position in the arrangement direction and the connection end portion adjacent thereto is greater than the interval between the two connection end portions present on the center side in the arrangement direction.

For example, in a case where the heater portion includes only two heater wires, four connection end portions are arranged side by side in the connection region. Here, the four connection end portions are defined as, from an end in the arrangement direction, a first connection end portion, a second connection end portion, a third connection end portion, and a fourth connection end portion. Then, in the electromagnetic wave transmissive cover according to the first aspect, in the general link portions, the interval between the first connection end portion and the second connection end portion, and the interval between the third connection end portion and the fourth connection end portion, can be considered to be greater than the interval between the second connection end portion and the third connection end portion.

In this case, the interval between the first connection end portion and the second connection end portion, and the interval between the third connection end portion and the fourth connection end portion, may be the same or different from each other.

For example, in a case where the heater portion includes three heater wires, six connection end portions are arranged side by side in the connection region. Here, the six connection end portions are defined as, from an end in the arrangement direction, a first connection end portion, a second connection end portion, a third connection end portion, a fourth connection end portion, a fifth connection end portion, and a sixth connection end portion. Then, in the electromagnetic wave transmissive cover according to the first aspect, in the general link portions, the interval between the first connection end portion and the second connection end portion, and the interval between the fifth connection end portion and the sixth connection end portion, can be considered to be greater than the interval between the third connection end portion and the fourth connection end portion.

In this case, the interval between the second connection end portion and the third connection end portion, and the interval between the fourth connection end portion and the fifth connection end portion, are not particularly limited. However, these two intervals are preferably greater than the interval between the third connection end portion and the fourth connection end portion, and particularly preferably, are approximately equal to the interval between the first connection end portion and the second connection end portion, and the interval between the fifth connection end portion and the sixth connection end portion.

In this case, the interval between the first connection end portion and the second connection end portion, and the interval between the fifth connection end portion and the sixth connection end portion, may be the same or different from each other.

In addition, the interval between the second connection end portion and the third connection end portion, and the interval between the fourth connection end portion and the fifth connection end portion, may also be the same or different from each other.

Where the interval between each connection end portion present at the endmost position in the arrangement direction and the connection end portion adjacent thereto is denoted by L1 and the interval between the two connection end portions present on the center side in the arrangement direction is denoted by L2, the relationship between the interval L1 and the interval L2 satisfies L1>L2. Preferably, the relationship satisfies 0.5×L1<L2<0.95×L1, 0.6×L1<L2<0.85×L1, or 0.65×L1<L2<0.8×L1, for example.

A specific value of the interval L2 is preferably 1.0 mm or more and less than 2 mm, 1.2 mm or more and 1.8 mm or less, or 1.3 mm or more and 1.6 mm or less. A specific value of the interval L1 is preferably 1.8 mm or more, 1.9 mm or more, or 2 mm or more. A preferable value of the interval L1 has no upper limit. However, the interval L1 is preferably 2.5 mm or less so that the outer shape of the electromagnetic wave transmissive cover does not become excessively large.

In the electromagnetic wave transmissive cover according to the second aspect of the present disclosure, in the general link portions, among the four connection end portions of the two heater wires, the electric resistances of the connection end portions present at the endmost positions on both sides in the arrangement direction are smaller than the electric resistances of the two connection end portions present on the center side in the arrangement direction.

For example, in a case where the heater portion includes only two heater wires, four connection end portions are arranged side by side in the connection region. Here, the four connection end portions are defined as, from an end in the arrangement direction, a first connection end portion, a second connection end portion, a third connection end portion, and a fourth connection end portion. Then, in the electromagnetic wave transmissive cover according to the second aspect, in the general link portions, the electric resistances of the first connection end portion and the fourth connection end portion can be considered to be smaller than the electric resistances of the second connection end portion and the third connection end portion.

In this case, the electric resistance of the first connection end portion and the electric resistance of the fourth connection end portion may be the same or different from each other. In addition, the electric resistance of the second connection end portion and the electric resistance of the third connection end portion may be the same or different from each other.

For example, in a case where the heater portion includes three heater wires, six connection end portions are arranged side by side in the connection region. Here, the six connection end portions are defined as, from an end in the arrangement direction, a first connection end portion, a second connection end portion, a third connection end portion, a fourth connection end portion, a fifth connection end portion, and a sixth connection end portion. Then, in the electromagnetic wave transmissive cover according to the second aspect, in the general link portions, the electric resistances of the first connection end portion and the sixth connection end portion can be considered to be smaller than the electric resistances of the third connection end portion and the fourth connection end portion.

In this case, the electric resistances of the second connection end portion and the fifth connection end portion are not particularly limited. However, these two electric resistances are preferably smaller than the electric resistances of the third connection end portion and the fourth connection end portion, and particularly preferably, are approximately equal to the electric resistances of the first connection end portion and the sixth connection end portion.

In this case, the electric resistance of the first connection end portion and the electric resistance of the sixth connection end portion may be the same or different from each other. In addition, the electric resistance of the third connection end portion and the electric resistance of the fourth connection end portion may be the same or different from each other. Further, the electric resistance of the second connection end portion and the electric resistance of the fifth connection end portion may be the same or different from each other.

Where the electric resistances of the two connection end portions present at the endmost positions in the arrangement direction are denoted by Ω1 and the electric resistances of the two connection end portions present on the center side in the arrangement direction are denoted by Ω2, the relationship between the electric resistances Ω1 and Ω2 satisfies Ω1<Ω2. Preferably, the relationship satisfies 0.75×Ω2<Ω1<0.98×Ω2, 0.80×Ω2<Ω1<0.95×Ω2, or 0.85×Ω2<Ω1<0.93×Ω2, for example.

A method for providing a difference between the electric resistances Ω1 and Ω2 of the connection end portions is not particularly limited. For example, a method of changing the materials or the sectional areas of the connection end portions may be selected. For example, as long as the amounts of currents flowing through the connection end portions are the same, the connection end portion having a small sectional area has a greater resistance than the connection end portion having a large sectional area.

For example, the electric resistance of the general heater portion may be the same as or different from the electric resistance of the connection end portion. In view of the heating function of the heater portion, the electric resistance of the general heater portion is preferably the same among the heater wires. In this case, electric resistances may be changed between the general heater portion and the connection end portion of the same heater wire.

Hereinafter, the electromagnetic wave transmissive cover and the electromagnetic wave radar unit according to the present disclosure will be described using specific examples.

### Embodiment 1

Embodiment 1 relates to the electromagnetic wave transmissive cover and the electromagnetic wave radar unit according to the first aspect.

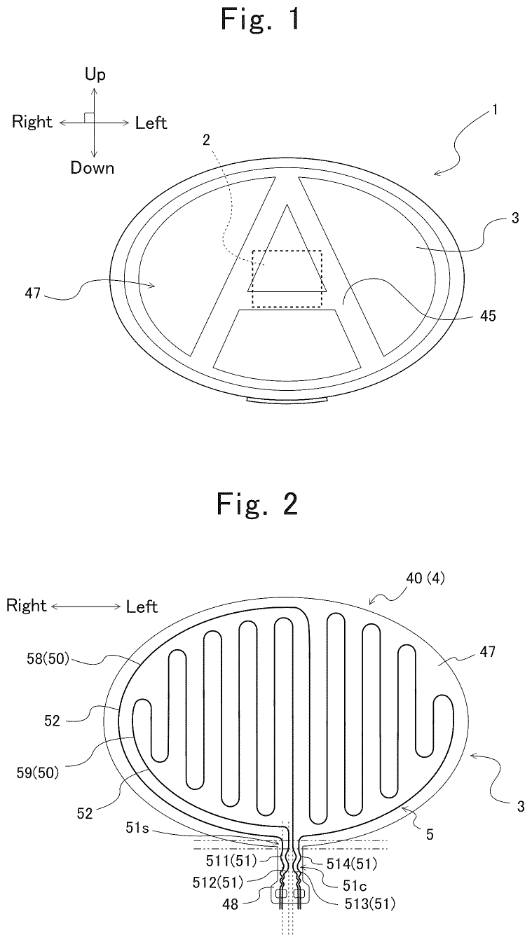

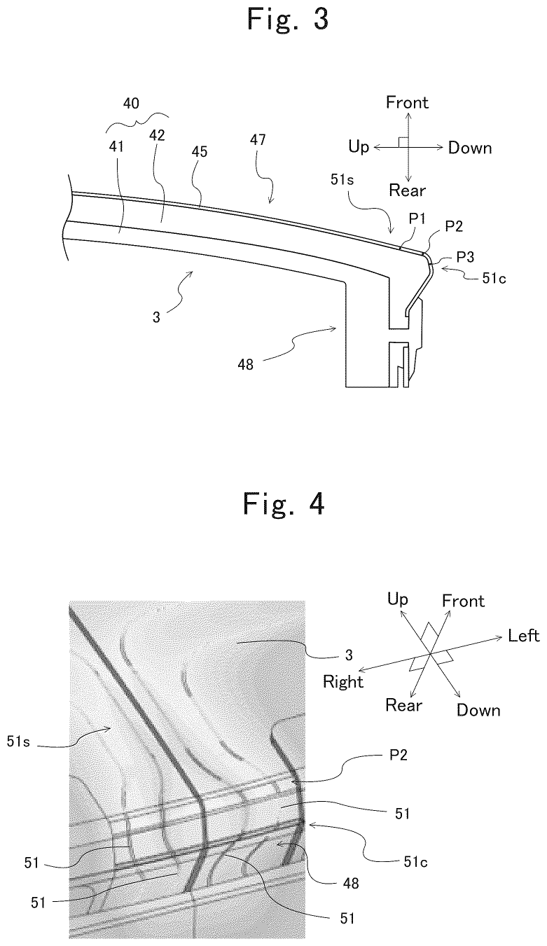

FIG. 1 schematically illustrates an electromagnetic wave radar unit including an electromagnetic wave transmissive cover of embodiment 1 as seen from an outer side. FIG. 2 schematically illustrates the positional relationship between a cover body portion and a heater portion in the electromagnetic wave transmissive cover of embodiment 1. FIG. 3 schematically illustrates a state in which the electromagnetic wave transmissive cover of embodiment 1 is cut in the thickness direction. FIG. 4 schematically illustrates a connection region and connection end portions in the electromagnetic wave transmissive cover of embodiment 1.

Hereinafter, in embodiments, up, down, left, right, front, and rear refer to up, down, left, right, front, and rear in the drawings. A front side is a forward side in the vehicle advancing direction, and a rear side is a backward side in the vehicle advancing direction.

As shown in FIG. 1, an electromagnetic wave radar unit 1 according to embodiment 1 includes an electromagnetic wave radar 2 and an electromagnetic wave transmissive cover 3.

The electromagnetic wave radar 2 is a millimeter-wave radar for vehicle.

The electromagnetic wave radar 2 is provided on the front end side in the vehicle, specifically, in a region on the front side in an engine room, and emits a millimeter wave frontward.

The electromagnetic wave transmissive cover 3 is provided on the front side of the electromagnetic wave radar 2. The electromagnetic wave transmissive cover 3 is an emblem and is fixed to a front grille (not shown) of the vehicle.

The electromagnetic wave transmissive cover 3 includes a cover body portion 4 and a heater portion 5.

As shown in FIG. 3, the cover body portion 4 has a substantially three-layer structure in which a design layer 45 is formed on a substrate layer 40 having a two-layer structure.

Of the substrate layer 40, a rear layer 41 located on the rear side, in other words, on the electromagnetic wave radar 2 side, is made of AES and has a substantially plate shape. Of the substrate layer 40, a front layer 42 located on the front side, in other words, on the side opposite to the electromagnetic wave radar 2, is made of PC and has a substantially plate shape. AES and PC are resins having glass transition temperatures of 120° C. or more and 140° C. or less.

The outer shape of the front layer 42 and the outer shape of the rear layer 41 are substantially the same shape, and the front layer 42 and the rear layer 41 are integrally molded through insert molding described later.

As shown in FIG. 2, the substrate layer 40 has a part having a substantially elliptic shape, and a part having a substantially strip shape. The part having the substantially elliptic shape and the part having the substantially strip shape are formed by the front layer 42 and the rear layer 41. The part having the strip shape extends rearward and outward in the radial direction from a peripheral edge of the part having the elliptic shape.

The part having the substantially elliptic shape in the substrate layer 40 forms a heating region 47 of the electromagnetic wave transmissive cover 3 of embodiment 1. The part having the substantially strip shape in the substrate layer 40 forms a connection region 48 of the electromagnetic wave transmissive cover 3 of embodiment 1.

In the electromagnetic wave transmissive cover 3 of embodiment 1, where the projected area of the heating region 47 is defined as 100% by area, the projected area of the connection region 48 is approximately 5% by area.

As shown in FIG. 1 and FIG. 3, the design layer 45 is provided on the front side in the heating region 47. Specifically, the design layer 45 is printed and formed on the front surface of the front layer 42, using ink having an electromagnetic wave transmitting property as a material.

As shown in FIG. 2, the heater portion 5 includes two heater wires 50. Each heater wire 50 is formed by printing a composite material of resin and copper powder on the cover body portion 4. Both end portions of each heater wire 50 are connection end portions 51, and a general heater portion 52 which is a remaining part links the two connection end portions 51.

The general heater portion 52 of each heater wire 50 is folded at substantially equal intervals and arranged substantially uniformly over the entirety of the heating region 47.

The connection end portions 51 of the heater wires 50 are gathered in the connection region 48, and are arranged side by side in the connection region 48.

In the electromagnetic wave transmissive cover 3 of embodiment 1, each heater wire 50 is interposed between the front layer 42 and the rear layer 41 of the substrate layer 40 in the cover body portion 4.

In the electromagnetic wave transmissive cover 3 of embodiment 1, the heater wires 50 are printed and formed on the rear surface of the front layer 42 molded in advance. Then, the substrate layer 40 of the cover body portion 4 is molded through insert molding in which the rear layer 41 is molded using, as an insert, the front layer 42 with the heater wires 50 formed thereon. The design layer 45 is further printed and formed on the front surface of the substrate layer 40, whereby the cover body portion 4 is obtained.

As shown in FIG. 2, in the electromagnetic wave transmissive cover 3 of embodiment 1, the heater portion 5 includes two heater wires 50, and four connection end portions 51 are arranged side by side in the connection region 48. The connection end portions 51 of the heater wires 50 are gathered in the connection region 48.

The four connection end portions 51 are defined as, from an end in the arrangement direction, i.e., the left-right direction in FIG. 2, a first connection end portion 511, a second connection end portion 512, a third connection end portion 513, and a fourth connection end portion 514.

In the electromagnetic wave transmissive cover 3 of embodiment 1, one connection end portion 51 of a first heater wire 58 which is one of the two heater wires 50 is the first connection end portion 511, and the other connection end portion 51 is the fourth connection end portion 514. In addition, one connection end portion 51 of a second heater wire 59 which is the other one of the two heater wires 50 is the second connection end portion 512, and the other connection end portion 51 is the third connection end portion 513.

In the connection region 48, the first connection end portion 511, the second connection end portion 512, the third connection end portion 513, and the fourth connection end portion 514 extend in the longitudinal direction of the connection region 48. Of the first connection end portion 511, the second connection end portion 512, the third connection end portion 513, and the fourth connection end portion 514, parts on the general heater portion 52 side, in other words, parts on the heating region 47 side extend straightly. The parts extending straightly are general link portions 51s of the connection end portions 51.

Of the general link portion 51s, a part on the side opposite to the general heater portion 52 is bent substantially twice from the bending start portion P2 shown in FIG. 3 as a boundary, and extends in a direction crossing the general link portion 51s. The part extending in the direction crossing the general link portion 51s is crossing extending portion 51c of each connection end portion 51.

The general link portion 51s can be considered to be a part contiguous to the general heater portion 52, of the connection end portion 51. The crossing extending portion 51c can be considered to be a part connected to an element device (not shown).

The first connection end portion 511 and the fourth connection end portion 514 have symmetric shapes in the arrangement direction, and the second connection end portion 512 and the third connection end portion 513 also have symmetric shapes in the arrangement direction.

The connection end portions 51 extend in parallel to each other in the general link portions 51s.

In the general link portions 51s, the interval between the first connection end portion 511 and the second connection end portion 512, and the interval between the third connection end portion 513 and the fourth connection end portion 514, are approximately 2 mm, and the interval between the second connection end portion 512 and the third connection end portion 513 is approximately 1.4 to 1.5 mm. Therefore, in the general link portions 51s, the interval between the first connection end portion 511 and the second connection end portion 512, and the interval between the third connection end portion 513 and the fourth connection end portion 514, are greater than the interval between the second connection end portion 512 and the third connection end portion 513.

In the electromagnetic wave transmissive cover 3 of embodiment 1, the relationship between: the interval between the first connection end portion 511 and the second connection end portion 512 and the interval L1 between the third connection end portion 513 and the fourth connection end portion 514; and the interval L2 between the second connection end portion 512 and the third connection end portion 513, satisfies 0.7×L1≤L2≤0.75×L1.

For reference, regarding the general heater portions 52 of the heater wires 50 located in the heating region 47, the interval between the adjacent general heater portions 52 is 1.6 mm or more and thus is much greater than the interval L1. The crossing angle θ of the crossing extending portion 51c with respect to the general link portion 51 s is in a range of 0°<θ<150°.

### Comparative Example

An electromagnetic wave transmissive cover of a comparative example is substantially the same as the electromagnetic wave transmissive cover of embodiment 1 except for arrangement of the connection end portions in the connection region.

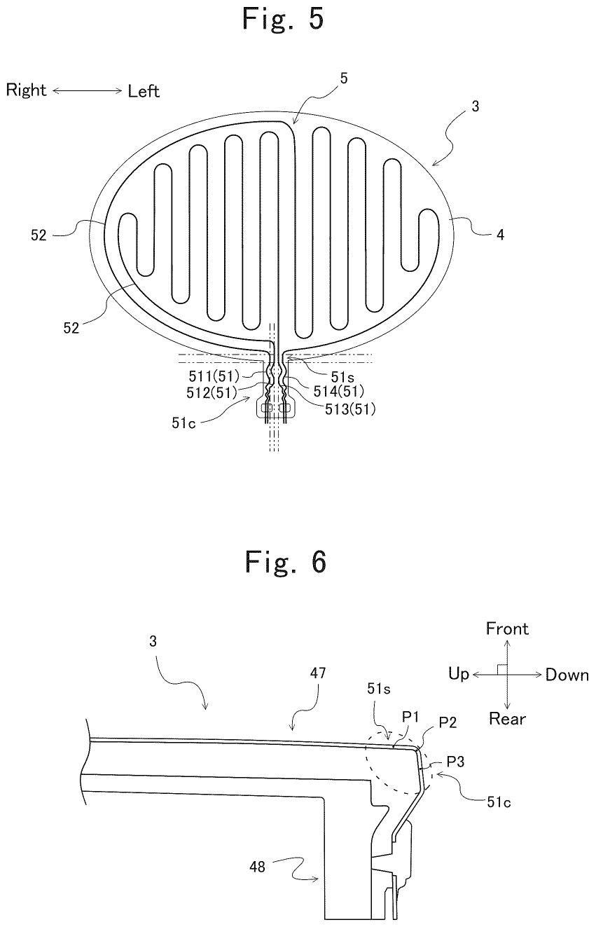

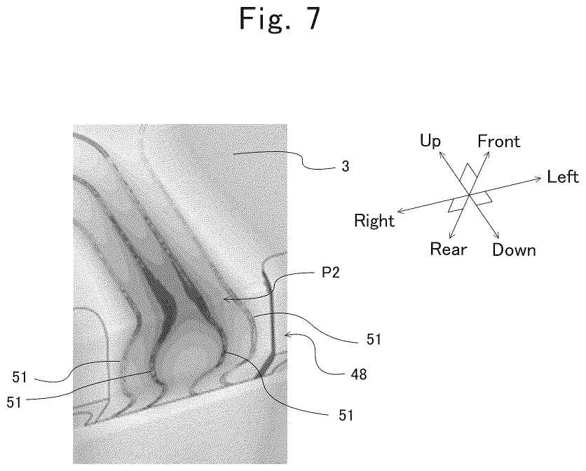

FIG. 5 schematically illustrates the positional relationship between a cover body portion and a heater portion in the electromagnetic wave transmissive cover of the comparative example. FIG. 6 schematically illustrates a state in which the electromagnetic wave transmissive cover of the comparative example is cut in the thickness direction. FIG. 7 schematically illustrates a connection region and connection end portions in the electromagnetic wave transmissive cover of the comparative example.

Hereinafter, the electromagnetic wave transmissive cover of the comparative example will be described focusing on a difference from the electromagnetic wave transmissive cover of embodiment 1.

The electromagnetic wave transmissive cover 3 of the comparative example is greatly different from the electromagnetic wave transmissive cover 3 of embodiment 1, regarding the interval between the adjacent connection end portions 51.

As shown in FIG. 5, also in the electromagnetic wave transmissive cover 3 of the comparative example, the connection end portions 51 extend in parallel to each other in the general link portions 51s.

In the general link portions 51s, the interval between the first connection end portion 511 and the second connection end portion 512, the interval between the third connection end portion 513 and the fourth connection end portion 514, and the interval between the second connection end portion 512 and the third connection end portion 513, are approximately 1.4 to 1.5 mm. Therefore, in the electromagnetic wave transmissive cover 3 of the comparative example, in the general link portions 51s, the interval between the first connection end portion 511 and the second connection end portion 512, and the interval between the third connection end portion 513 and the fourth connection end portion 514, are substantially the same as the interval between the second connection end portion 512 and the third connection end portion 513.

In the electromagnetic wave transmissive cover 3 of the comparative example, in the general link portions 51s, the electric resistances of the first connection end portion 511 and the fourth connection end portion 514 exhibited greater values than the electric resistances of the second connection end portion 512 and the third connection end portion 513.

Specifically, in the general link portions 51s, where the electric resistances of the first connection end portion 511 and the fourth connection end portion 514 are denoted by Ω1 and the electric resistances of the second connection end portion 512 and the third connection end portion 513 are denoted by Ω2, Ω1 was approximately 1.1×Ω2, and the relationship between the electric resistances Ω1 and Ω2 satisfies Ω1>Ω2.

### Embodiment 2

Embodiment 2 relates to the electromagnetic wave transmissive cover and the electromagnetic wave radar unit according to the second aspect.

The electromagnetic wave transmissive cover of embodiment 2 is substantially the same as the electromagnetic wave transmissive cover of the comparative example except for the electric resistances of the connection end portions.

Hereinafter, the electromagnetic wave transmissive cover of embodiment 2 will be described focusing on a difference from the electromagnetic wave transmissive cover of the comparative example.

Also in the electromagnetic wave transmissive cover 3 of embodiment 2, the connection end portions extend in parallel to each other in the general link portions 51s.

Also in the electromagnetic wave transmissive cover 3 of embodiment 2, as in the electromagnetic wave transmissive cover 3 of the comparative example, in the general link portions 51s, the interval between the first connection end portion 511 and the second connection end portion 512, the interval between the third connection end portion 513 and the fourth connection end portion 514, and the interval between the second connection end portion 512 and the third connection end portion 513, are approximately 1.4 to 1.5 mm. Therefore, also in the electromagnetic wave transmissive cover 3 of embodiment 2, in the general link portions 51s, the interval between the first connection end portion 511 and the second connection end portion 512, and the interval between the third connection end portion 513 and the fourth connection end portion 514, are substantially the same as the interval between the second connection end portion 512 and the third connection end portion 513.

However, the electromagnetic wave transmissive cover 3 of embodiment 2 is different from the electromagnetic wave transmissive cover 3 of the comparative example, regarding the electric resistances of the connection end portions 51.

Specifically, the sectional areas of the two connection end portions 51, i.e., the first connection end portion 511 and the fourth connection end portion 514, of the first heater wire 58 are larger than the sectional area of the general heater portion 52 of the same first heater wire 58. In other words, the wire diameters of the first connection end portion 511 and the fourth connection end portion 514 of the first heater wire 58 are greater than the wire diameter of the general heater portion 52 of the same first heater wire 58.

On the other hand, the wire diameter of the second heater wire 59 is substantially constant over the entire length, and is substantially the same as the wire diameter of the general heater portion 52 of the first heater wire 58.

Therefore, in the electromagnetic wave transmissive cover 3 of embodiment 2, in the general link portions 51s, the electric resistances of the first connection end portion 511 and the fourth connection end portion 514 are smaller than the electric resistances of the second connection end portion 512 and the third connection end portion 513.

Specifically, in the general link portions 51s, where the electric resistances of the first connection end portion 511 and the fourth connection end portion 514 are denoted by Ω1 and the electric resistances of the second connection end portion 512 and the third connection end portion 513 are denoted by Ω2, Ω1 was approximately 0.9×Ω2, and the relationship between the electric resistances Ω1 and Ω2 satisfied Ω1<Ω2, and more specifically, satisfied 0.85×Ω2<Ω1<0.93×Ω2.

### (Evaluation Test 1)

Regarding the electromagnetic wave transmissive cover 3 of embodiment 1 and the electromagnetic wave transmissive cover 3 of the comparative example, the temperature in the connection region 48 when the temperature of the heater portion 5 was increased so that the temperature in the heating region 47 became approximately 100° C., was evaluated through CAE analysis.

As a result, in the electromagnetic wave transmissive cover 3 of the comparative example, the temperature in the connection region 48 increased up to 118° C. at a highest-temperature part. As shown in FIG. 7, at that time, many dark-color parts indicating that 110° C. was exceeded were seen in the connection region 48 of the electromagnetic wave transmissive cover 3 of the comparative example. In the electromagnetic wave transmissive cover 3 of the comparative example, the temperature increased particularly at a part where the general link portions 51s are present in the connection region 48, in other words, a part on the heating region 47 side in the connection region 48, as indicated by a broken line in FIG. 6.

On the other hand, in the electromagnetic wave transmissive cover 3 of embodiment 1, the temperature in the connection region 48 was not higher than 103° C. even at a highest-temperature part. As shown in FIG. 4, at that time, no dark-color parts were seen in the connection region 48 of the electromagnetic wave transmissive cover 3 of embodiment 1.

From the above result, the following fact is supported. That is, in the general link portions 51s, when the interval between the first connection end portion 511 and the second connection end portion 512, and the interval between the third connection end portion 513 and the fourth connection end portion 514, are set to be greater than the interval between the second connection end portion 512 and the third connection end portion 513, excessive temperature increase in the heater wires 50 in the connection end portions 51 is prevented, and thus excessive temperature increase in the connection region 48 is prevented.

That is, the above result supports the fact that the electromagnetic wave radar unit 1 according to the first aspect and the electromagnetic wave transmissive cover 3 according to the first aspect of the present disclosure prevent concentration of heat generation in the cover body portion 4 of the electromagnetic wave transmissive cover 3.

### (Evaluation Test 2)

Regarding the electromagnetic wave transmissive cover 3 of embodiment 2, as in the evaluation test 1, the temperature in the connection region 48 when the temperature of the heater portion 5 was increased so that the temperature in the heating region 47 became approximately 100° C. was evaluated through CAE analysis.

As described above, in the electromagnetic wave transmissive cover 3 of the comparative example, the temperature in the connection region 48 increased up to 118° C. at a highest-temperature part. On the other hand, in the electromagnetic wave transmissive cover 3 of embodiment 2, the temperature in the connection region 48 was lower than that in the comparative example.

From the above result, the following fact is supported. That is, in the general link portions 51s, when the electric resistances of the first connection end portion 511 and the fourth connection end portion 514 are set to be smaller than the electric resistances of the second connection end portion 512 and the third connection end portion 513, excessive temperature increase in the heater wires 50 in the connection end portions 51 is prevented, and thus excessive temperature increase in the connection region 48 is prevented.

That is, the above result supports the fact that the electromagnetic wave radar unit 1 according to the second aspect and the electromagnetic wave transmissive cover 3 according to the second aspect of the present disclosure prevent deformation of the cover body portion 4 in the electromagnetic wave transmissive cover 3.

While the present disclosure has been described above, the present disclosure is not limited to the embodiments and the like described above. Elements described in the embodiments and the like may be extracted and combined as appropriate to implement the present disclosure, and various modifications may be made without deviating from the scope of the present disclosure.

The specification of the present disclosure discloses not only technical features based on the reference relationship of the claims at the time of filing of the present application but also technical features obtained by combining matters described in the claims as appropriate.

1. An electromagnetic wave transmissive cover provided on an outer side of an electromagnetic wave radar, the electromagnetic wave transmissive cover comprising:
a cover body portion formed in a plate shape and having an electromagnetic wave transmitting property, the cover body portion being made of a resin material; and
a heater portion including two heater wires and provided integrally with the cover body portion, wherein
each of the heater wires includes connection end portions which are both ends, and a general heater portion which is a remaining part and links the two connection end portions,
the connection end portions are arranged side by side in a connection region which is an end portion of the electromagnetic wave transmissive cover and extends outward,
each of the connection end portions includes a general link portion contiguous to the general heater portion, and a crossing extending portion contiguous to the general link portion and extending in a direction crossing the general link portion, and
in the general link portions, among the four connection end portions of the two heater wires, an interval between each connection end portion present at an endmost position in an arrangement direction and the connection end portion adjacent thereto is greater than an interval between the two connection end portions present on a center side in the arrangement direction.

2. An electromagnetic wave transmissive cover provided on an outer side of an electromagnetic wave radar, the electromagnetic wave transmissive cover comprising:
a cover body portion formed in a plate shape and having an electromagnetic wave transmitting property, the cover body portion being made of a resin material; and
a heater portion including two heater wires and provided integrally with the cover body portion, wherein
each of the heater wires includes connection end portions which are both ends, and a general heater portion which is a remaining part and links the two connection end portions,
the connection end portions are arranged side by side in a connection region which is an end portion of the electromagnetic wave transmissive cover and extends outward,
each of the connection end portions includes a general link portion contiguous to the general heater portion, and a crossing extending portion contiguous to the general link portion and extending in a direction crossing the general link portion, and
in the general link portions, among the four connection end portions of the two heater wires, electric resistances of the connection end portions present at endmost positions on both sides in an arrangement direction are smaller than electric resistances of the two connection end portions present on a center side in the arrangement direction.

3. The electromagnetic wave transmissive cover according to claim 1, wherein
the cover body portion is made of resin having a glass transition temperature of 120° C. or more and 140° C. or less.

4. The electromagnetic wave transmissive cover according to claim 2, wherein
the cover body portion is made of resin having a glass transition temperature of 120° C. or more and 140° C. or less.
